(19) United States
(12) Patent Application Publication
(10) Pub. No.: US 2019/0339992 A1
(43) Pub. Date: Nov. 7, 2019

(54) MODIFYING OPERATING SETTINGS BASED ON SYSTEM PERFORMANCE DATA

(71) Applicant: Lenovo Enterprise Solutions (Singapore) Pte. Ltd., Singapore (SG)

(72) Inventors: Jamaica Laquay Barnette, Durham, NC (US); Brian Christopher Totten, Durham, NC (US); Delali Dogbey, Morrisville, NC (US); Douglas Evans, Cary, NC (US); Dipak Tailor, Cary, NC (US)

(21) Appl. No.: 15/968,615

(22) Filed: May 1, 2018

(51) Int. Cl. G06F 9/445; G06F 11/34; G06F 11/30

(52) U.S. Cl. CPC G06F 9/44505; G06F 11/3024; G06F 11/3409

(57) ABSTRACT

A computer-implemented method, according to one embodiment, includes: monitoring one or more types of system performance data, determining whether a current value corresponding to each of the types of system performance data is outside a respective predefined range, sending instructions to make adjustments to settings of a voltage regulator in response to determining that a current value corresponding to one of the types of system performance data is outside a respective predefined range, and performing an iterative process. The iterative process includes: determining whether an updated value corresponding to the one of the types of system performance data is outside the respective predefined range, and sending instructions to make additional adjustments to the settings of the voltage regulator in response to determining that the updated value corresponding to the one of the types of system performance data is outside the respective predefined range.

### FIELD OF THE INVENTION

The present invention relates to managing system operating settings, and more particularly, this invention relates to improving system performance by selectively modifying operating settings.

### BACKGROUND

A power supply is an electrical device that supplies electric power to an electrical load by converting electric current from a source to the correct voltage, current, and frequency to power the load. Moreover, a voltage regulator is an electronic circuit that provides a stable direct current (DC) voltage independent of the load current, temperature and AC line voltage variations. Accordingly, power supplies and voltage regulators are used to provide a desired electrical supply to the various electrical components included in a given system (e.g., such as a server).

Heat is a thermal byproduct generated by various components in a system during normal operation. The amount of heat generated may depend on the operational conditions of the system, including voltage regulator characteristics and system loading. In some system loading instances, thermal runaway of a particular device may occur, or the temperature of a component may exceed a safe operating temperature range.

Some conventional products attempt to counteract “global” thermal spikes experienced in the system by adjusting cooling fan speeds or by throttling down system activity. While these adjustments may reduce operating temperatures, they do so at a significant cost, as increasing cooling fan speeds causes excessive fan noise, and throttling down system activity results in undesirably low system performance.

Other conventional products attempt to combat “local” thermal spikes experienced by specific components by implementing thermal protections. For instance, some conventional products implement thermal protections which force a component to shut down and remain in a powered down state in response to an internal temperature of the component rising undesirably high. While these conventional products are able to protect the various components from damage caused by operating at high temperatures, forced component shut downs cause the system to unexpectedly halt and remain in a degraded state, thereby significantly hindering system performance.

Accordingly, conventional products are unable to account for thermal spikes without causing detriment to the performance of the system and/or specific components included therein.

### SUMMARY

A computer-implemented method, according to one embodiment, includes: monitoring one or more types of system performance data, determining whether a current value corresponding to each of the one or more types of system performance data is outside a respective predefined range, sending one or more instructions to make adjustments to settings of a voltage regulator in response to determining that a current value corresponding to one of the one or more types of system performance data is outside a respective predefined range, and performing an iterative process. The iterative process includes: determining whether an updated value corresponding to the one of the one or more types of system performance data is outside the respective predefined range, and sending one or more instructions to make additional adjustments to the settings of the voltage regulator in response to determining that the updated value corresponding to the one of the one or more types of system performance data is outside the respective predefined range.

A computer program product, according to another embodiment, is for adjusting voltage settings. The computer program product includes a non-transitory computer readable storage medium, the computer readable storage medium having program code stored thereon. Moreover, the program code is executable by a computer to cause the computer to perform a process which includes: monitoring, by the computer, one or more types of system performance data; determining, by the computer, whether a current value corresponding to each of the one or more types of system performance data is outside a respective predefined range; sending, by the computer, one or more instructions to make adjustments to settings of a voltage regulator in response to determining that a current value corresponding to one of the one or more types of system performance data is outside a respective predefined range; and performing, by the computer, an iterative process. Moreover, the iterative process includes: determining whether an updated value corresponding to the one of the one or more types of system performance data is outside the respective predefined range, and sending one or more instructions to make additional adjustments to the settings of the voltage regulator in response to determining that the updated value corresponding to the one of the one or more types of system performance data is outside the respective predefined range.

A system, according to yet another embodiment, includes: a voltage regulator; a processor in communication with the voltage regulator; and logic executable by the processor. Moreover, the logic is configured to: monitor, by the processor, one or more types of system performance data; determine, by the processor, whether a current value corresponding to each of the one or more types of system performance data is outside a respective predefined range; send, by the processor, one or more instructions to make adjustments to settings of a voltage regulator in response to determining that a current value corresponding to one of the one or more types of system performance data is outside a respective predefined range; and perform, by the processor, an iterative process. The iterative process includes: determining whether an updated value corresponding to the one of the one or more types of system performance data is outside the respective predefined range; and sending one or more instructions to make additional adjustments to the settings of the voltage regulator in response to determining that the updated value corresponding to the one of the one or more types of system performance data is outside the respective predefined range.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a partial representational view of a network architecture in accordance with one embodiment.

FIG. 2 is a partial representational view of a hardware environment in accordance with one embodiment.

FIG. 3 is a partial representational view of a system in accordance with one embodiment.

FIG. 4 is a flowchart of a method in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a”, “an”, and “the” include plural referents unless otherwise specified.

The following description discloses several preferred embodiments of efficient operation management scheme and/or related systems and methods. Various ones of the approaches included herein may be able to counteract various different system performance situations, while also ensuring the system remains fully operational. Some of the approaches included herein are able to achieve this operational stability by dynamically adjusting voltage regulator settings and/or power supply settings. Moreover, these adjustments may be made based on current system performance data, thereby enabling an efficient operation management scheme which efficiently adapts to the system as it changes over time and with use, e.g., as will be described in further detail below.

In one general embodiment, a computer-implemented method includes: monitoring one or more types of system performance data, determining whether a current value corresponding to each of the one or more types of system performance data is outside a respective predefined range, sending one or more instructions to make adjustments to settings of a voltage regulator in response to determining that a current value corresponding to one of the one or more types of system performance data is outside a respective predefined range, and performing an iterative process. The iterative process includes: determining whether an updated value corresponding to the one of the one or more types of system performance data is outside the respective predefined range, and sending one or more instructions to make additional adjustments to the settings of the voltage regulator in response to determining that the updated value corresponding to the one of the one or more types of system performance data is outside the respective predefined range.

In another general embodiment, a computer program product is for adjusting voltage settings. The computer program product includes a non-transitory computer readable storage medium, the computer readable storage medium having program code stored thereon. Moreover, the program code is executable by a computer to cause the computer to perform a process which includes: monitoring, by the computer, one or more types of system performance data; determining, by the computer, whether a current value corresponding to each of the one or more types of system performance data is outside a respective predefined range; sending, by the computer, one or more instructions to make adjustments to settings of a voltage regulator in response to determining that a current value corresponding to one of the one or more types of system performance data is outside a respective predefined range; and performing, by the computer, an iterative process. Moreover, the iterative process includes: determining whether an updated value corresponding to the one of the one or more types of system performance data is outside the respective predefined range, and sending one or more instructions to make additional adjustments to the settings of the voltage regulator in response to determining that the updated value corresponding to the one of the one or more types of system performance data is outside the respective predefined range.

In yet another general embodiment, a system includes: a voltage regulator; a processor in communication with the voltage regulator; and logic executable by the processor. Moreover, the logic is configured to: monitor, by the processor, one or more types of system performance data; determine, by the processor, whether a current value corresponding to each of the one or more types of system performance data is outside a respective predefined range; send, by the processor, one or more instructions to make adjustments to settings of a voltage regulator in response to determining that a current value corresponding to one of the one or more types of system performance data is outside a respective predefined range; and perform, by the processor, an iterative process. The iterative process includes: determining whether an updated value corresponding to the one of the one or more types of system performance data is outside the respective predefined range; and sending one or more instructions to make additional adjustments to the settings of the voltage regulator in response to determining that the updated value corresponding to the one of the one or more types of system performance data is outside the respective predefined range.

The description herein is presented to enable any person skilled in the art to make and use the invention and is provided in the context of particular applications of the invention and their limits. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

In particular, various embodiments of the invention discussed herein are implemented using the Internet as a means of communicating among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN) or other means of communication. In addition, various combinations of wired, wireless (e.g., radio frequency) and optical communication links may be utilized.

The program environment in which one embodiment of the invention may be executed illustratively incorporates one or more general-purpose computers or special-purpose devices such hand-held computers. Details of such devices (e.g., processor, memory, data storage, input and output devices) are well known and are omitted for the sake of clarity.

It should also be understood that the techniques of the present invention might be implemented using a variety of technologies. For example, the methods described herein may be implemented in software running on a computer system, or implemented in hardware utilizing one or more processors and logic (hardware and/or software) for performing operations of the method, application specific integrated circuits, programmable logic devices such as Field Programmable Gate Arrays (FPGAs), and/or various combinations thereof. In one illustrative approach, methods described herein may be implemented by a series of computer-executable instructions residing on a storage medium such as a physical (e.g., non-transitory) computer-readable medium. In addition, although specific embodiments of the invention may employ object-oriented software programming concepts, the invention is not so limited and is easily adapted to employ other forms of directing the operation of a computer.

The invention can also be provided in the form of a computer program product comprising a computer readable storage or signal medium having computer code thereon, which may be executed by a computing device (e.g., a processor) and/or system. A computer readable storage medium can include any medium capable of storing computer code (e.g., program code) thereon for use by a computing device or system, including optical media such as read only and writeable CD and DVD, magnetic memory or medium (e.g., hard disk drive, tape), semiconductor memory (e.g., FLASH memory and other portable memory cards, etc.), firmware encoded in a chip, etc.

A computer readable signal medium is one that does not fit within the aforementioned storage medium class. For example, illustrative computer readable signal media communicate or otherwise transfer transitory signals within a system, between systems e.g., via a physical or virtual network, etc.

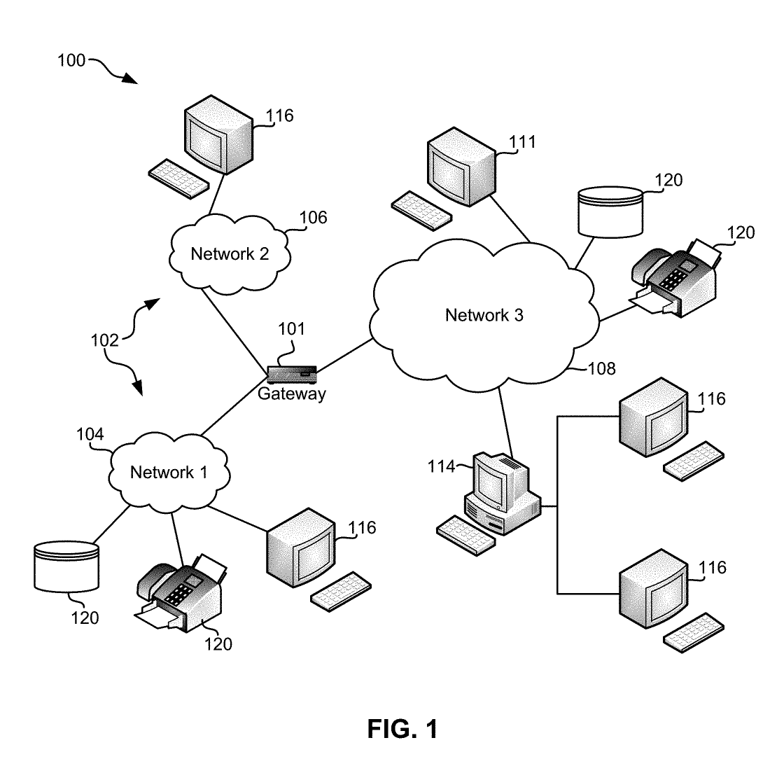

FIG. 1 illustrates a network architecture 100, in accordance with one embodiment. As an option, the present network architecture 100 may be implemented in conjunction with features from any other embodiment listed herein, such as those described with reference to the other FIGS. Of course, however, such network architecture 100 and others presented herein may be used in various applications and/or in permutations which may or may not be specifically described in the illustrative embodiments listed herein. Further, the network architecture 100 presented herein may be used in any desired environment.

As shown in FIG. 1, a plurality of remote networks 102 are provided including a first remote network 104 and a second remote network 106. A gateway 101 may be coupled between the remote networks 102 and a proximate network 108. In the context of the present network architecture 100, the networks 104, 106 may each take any form including, but not limited to a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. Such user devices 116 may include a desktop computer, laptop computer, hand-held computer, printer or any other type of logic. It should be noted that a user device 111 may also be directly coupled to any of the networks, in one embodiment.

A peripheral 120 or series of peripherals 120, e.g. facsimile machines, printers, networked storage units, etc., may be coupled to one or more of the networks 104, 106, 108. It should be noted that databases, servers, and/or additional electrical components may be utilized with, or integrated into, any type of network element coupled to the networks 104, 106, 108. In the context of the present description, a network element may refer to any electrical component of a network.

According to some approaches, methods and systems described herein may be implemented with and/or on virtual systems and/or systems which emulate one or more other systems, such as a UNIX system which emulates a MAC OS environment, a UNIX system which virtually hosts a MICROSOFT WINDOWS environment, a MICROSOFT WINDOWS system which emulates a MAC OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data processing and/or storage, servers, etc., are provided to any system in the cloud, preferably in an on-demand relationship, thereby allowing access and distribution of services across many computing systems. Cloud computing typically involves an Internet or other high speed connection (e.g., 4G LTE, fiber optic, etc.) between the systems operating in the cloud, but other techniques of connecting the systems may also be used.

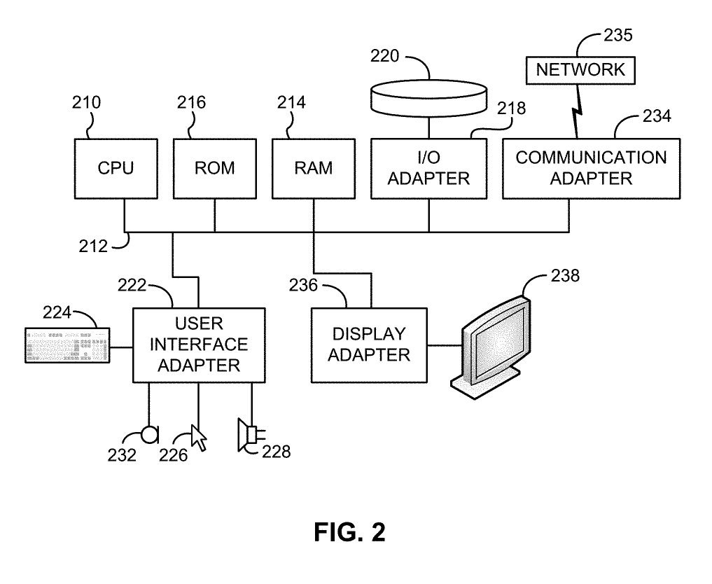

FIG. 2 shows a representative hardware environment 200 associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft WINDOWS Operating System (OS), a MAC OS, a UNIX OS, etc. It will be appreciated that a preferred embodiment may also be implemented on platforms and operating systems other than those mentioned. A preferred embodiment may be written using JAVA, XML, C, and/or C++ language, or other programming languages, along with an object oriented programming methodology. Object oriented programming (OOP), which has become increasingly used to develop complex applications, may be used.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

As previously mentioned, heat is a thermal byproduct generated by various components in a system during normal operation. The amount of heat generated may depend on the operational conditions of the system, including voltage regulator characteristics and system loading.

Some conventional products attempt to counteract “global” thermal spikes experienced in the system by adjusting cooling fan speeds or by throttling down system activity. However, these adjustments undesirably result in excessive fan noise, and detrimentally low system performance. Other conventional products implementing thermal protections in an attempt to combat “local” thermal spikes experienced by specific components. For instance, some conventional products implement thermal protections which force a component to shut down and remain in a powered down state in response to an internal temperature of the component rising undesirably high. However, forced component shut downs cause the system to unexpectedly halt and remain in a degraded state, thereby significantly hindering system performance. Accordingly, conventional products are unable to account for thermal spikes without causing detriment to the performance of the system and/or specific components included therein.

In sharp contrast to these conventional shortcomings, various ones of the approaches included herein may be able to counteract “global” thermal spikes as well as “local” thermal spikes while also ensuring the system remains fully operational. Some of the approaches included herein are able to achieve this thermal stability by dynamically adjusting voltage regulator settings and/or power supply settings. For instance, system thermal loads may be altered by adjusting voltage regulator settings, e.g., such as voltage set points, switching frequencies, current scaling, voltage amplitudes, etc. Moreover, these adjustments may be made based on current system performance data, thereby enabling a thermal management scheme which efficiently adapts to the system as it changes over time, e.g., as will be described in further detail below.

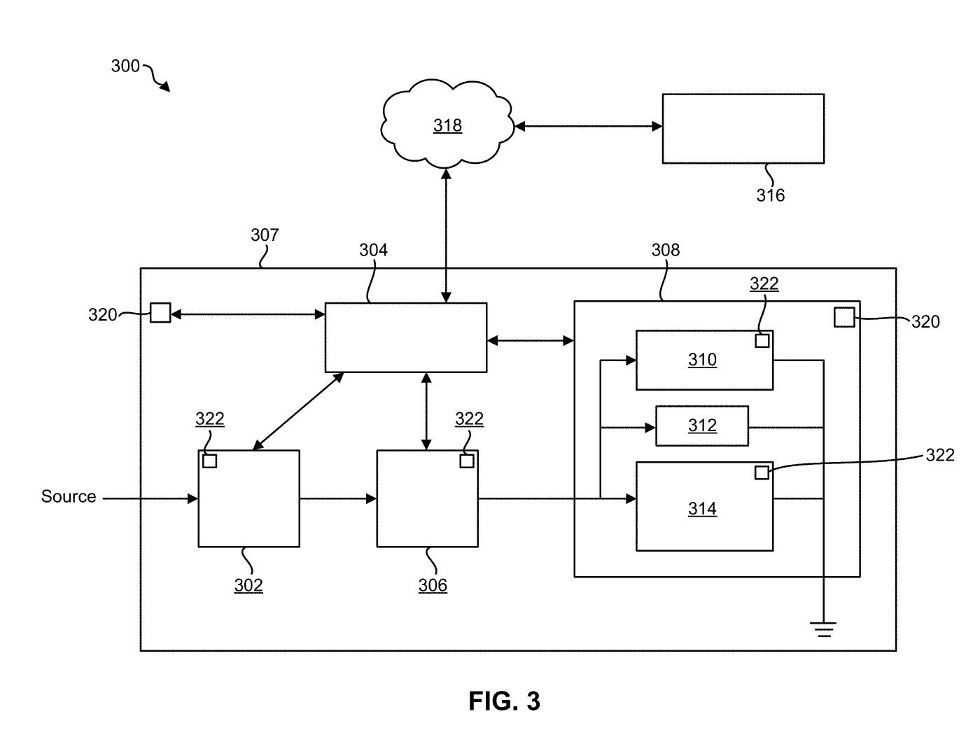

Looking to FIG. 3, a partial schematic view of a system 300 is illustrated in accordance with one embodiment. As an option, the present system 300 may be implemented in conjunction with features from any other embodiment listed herein, such as those described with reference to the other FIGS., such as FIGS. 1-2. However, such system 300 and others presented herein may be used in various applications and/or in permutations which may or may not be specifically described in the illustrative embodiments listed herein. Further, the system 300 presented herein may be used in any desired environment. Thus FIG. 3 (and the other FIGS.) may be deemed to include any possible permutation.

As shown, the system 300 includes a power supply 302, a controller 304 (e.g., a processor, FPGA, CPU, IC, etc.), and a voltage regulator 306, each of which are electrically coupled to each other. It should be noted that as used herein, components which are “electrically coupled” together may be coupled to each other using a wireless connection, e.g., WiFi, Bluetooth, a cellular network, etc.; a wired connection, e.g., a cable, a fiber-optic link, a wire, etc.; etc., or any other type of connection which would be apparent to one skilled in the art after reading the present description. Accordingly, the connection electrically coupling any two of the power supply 302, the controller 304, and the voltage regulator 306 together may vary depending on the desired approach. Moreover, components which are electrically coupled together are also preferably in communication with each other. In other words, components which are electrically coupled together are also preferably able to send information to and/or receive information from each other.

The power supply 302, controller 304, and voltage regulator 306 are also shown as being positioned in a same housing 307. Depending on the approach, the housing 307 may be a physical boundary which encloses the various components illustrated as being included therein and/or a logical boundary used to designate the specific components illustrated as being included therein. According to an exemplary approach, which is in no way intended to limit the invention, system 300 may be a server, whereby the housing 307 is a physical casing which encircles the various components illustrated in FIG. 3, thereby providing security; protecting against damage to the various components; serving as a barrier which dampens the effects caused by external temperatures, contaminants, humidity, etc.; etc.

The power supply 302 is also electrically coupled to a source which may provide electrical energy in the form of electrical current to the power supply 302. The electrical energy provided by the source may originate from an electric power grid (e.g., such as an electrical outlet), energy storage devices (e.g., such as batteries, fuel cells, etc.), generators, alternators, solar power converters, etc., or any other supply of electrical energy. Accordingly, the power supply 302 may be able to use the electrical energy of the source to produce an electrical output having a desired voltage, current, and/or frequency, e.g., using any components and/or processes which would be apparent to one skilled in the art after reading the present description.

The electrical output of the power supply 302 serves as an input for the voltage regulator 306 in the present embodiment. However, it should be noted that the architecture of system 300 is in no way intended to be limiting. For instance, in some embodiments the power supply 302 may include an internal voltage regulator (not shown). Accordingly, the power supply 302 may use the internal voltage regulator to achieve a stable voltage of the electrical output of the power supply 302, and voltage regulator 306 may not be implemented in some approaches, e.g., for deduplication purposes. However, in other approaches the internal voltage regulator of the power supply 302 may be implemented in combination with voltage regulator 306. It follows that, although not shown in FIG. 3, the various components included in system 300 (e.g., such as power supply 302, voltage regulator 306, controller 304, etc.) may include various other sub-components which may be used to achieve a desired result or output. For example, the power supply 302 may include one or more transformers, full-wave bridge rectifiers, filter capacitors, resistor load, etc., therein.

The electrical output of the power supply 302 is provided to a system load 308. In other words, the various electrical components 310, 312, 314 in the system load 308 are electrically coupled to the output of the voltage regulator 306. The output voltage achieved by the voltage regulator 306 may be independent of the load current, temperature, voltage supply variations, etc., thereby providing stable operating conditions for the system load 308 and the electrical components 310, 312, 314 included therein. In different approaches, the voltage regulator 306 may be able to achieve a stable output voltage by implementing a feed-forward design and/or negative feedback. Moreover, the voltage regulator 306 may use an electromechanical mechanism and/or electronic elements in order to regulate one or more alternate current (AC) and/or DC voltages, depending on the desired approach.

With continued reference to FIG. 3, the controller 304 is illustrated as being coupled to a host 316 (e.g., a user) through a network 318. Accordingly, the controller may be able to communicate with the host 316, receive instructions from the host 316, issue requests to the host 316, etc., depending on the desired approach. As mentioned above, the network 318 may take any desired form, e.g., including a LAN, a WAN (e.g., such as the Internet), a PSTN, an internal telephone network, etc. Accordingly, the controller 304 and host 316 may be located at a same physical location, spread across two or more different adjacent locations, located at different geographical locations, etc.

The controller 304 is also electrically coupled to the system load 308 and may thereby be able to determine information (e.g., such as the performance data) corresponding to the various electrical components 310, 312, 314 included in the system load 308. Accordingly, the controller may be able to send one or more instructions to any of the electrical components 310, 312, 314 shown in system 300. In some approaches, the controller 304 may also be able to send information to and/or receive information from a controller (not shown) which manages the various electrical components 310, 312, 314. In other approaches, the controller 304 may send information to and/or receive information from the various electrical components 310, 312, 314 themselves. In still other approaches, the controller 304 may obtain information (e.g., such as the performance data) corresponding to the various electrical components 310, 312, 314 from memory (e.g., a lookup table), product information, specification sheets, a user, overall performance of the system 300, an electrical output of the system load 308, an ambient thermal sensor 320 included in the system load 308, etc.

The system load 308 may include any number of various electrical components 310, 312, 314 included therein which are electrically coupled to the output of the voltage regulator 306. For instance, in some approaches the system 300 may be a server. Accordingly, one or more of the electrical components 310, 312, 314 may include electrical server components, e.g., such as connectors, cables, field-effect transistors (FETs), fuses, etc. Each of the electrical components 310, 312, 314 may also have different operation settings associated therewith. Thus, the various electrical components 310, 312, 314 included in the system load 308 may experience and/or cause different performance characteristics depending on the situation. Moreover, these different performance characteristics may have an effect on the desired settings of the voltage regulator 306 and/or power supply 302, e.g., as will be described in further detail below.

As previously mentioned, heat is a thermal byproduct generated by various components in a system during normal operation. The amount of heat generated by each of the components included in the system may depend on throughput, operating voltage, current draw, etc., of the respective component. Moreover, the aggregate amount of heat present in a system may depend on various operational conditions of the system, including voltage regulator characteristics and system loading. Accordingly, it is desirable that system 300 is able to determine an accurate representation of the various thermal settings thereof.

Referring still to FIG. 3, a plurality of thermal sensors 320, 322 are included throughout the system 300. Ambient thermal sensors 320 are positioned in open spaces of the system 300, while local thermal sensors 322 are positioned in and/or are coupled to various ones of the components included in system 300. The ambient thermal sensors 320 may be used to monitor the ambient temperature settings of respective areas in the housing 307 of system 300. Moreover, each of the local thermal sensors 322 may be used to monitor the temperature settings of the respective component corresponding thereto. According to an example, the local thermal sensor 322 included in the voltage regulator 306 may be used to monitor the internal temperature settings of the voltage regulator 306 and/or an area immediately surrounding the voltage regulator 306.

However, not all of the components included in system 300 include a respective local thermal sensors 322. For example, electrical component 312 in system load 308 does not include a local thermal sensors 322. Accordingly, ambient thermal sensor 320 positioned in the system load 308 may be used to monitor the temperature settings of electrical component 312 itself and/or the effects that the electrical component 312 has on the thermal settings of the system load 308 as a whole. It follows that the ambient thermal sensors 320 may be used to monitor “global” thermal settings of the system 300, while local thermal sensors 322 are used to monitor “local” thermal settings which correspond to individual components of the system 300.

According to some approaches, the ambient thermal sensors 320 may be coupled (e.g., affixed) to the housing 307. Similarly, the local thermal sensors 322 may be coupled to an exterior of the corresponding component. However, in other approaches, the local thermal sensors 322 may be coupled to various internal portions of the corresponding component. In other words, the local thermal sensors 322 may be positioned inside the corresponding component in some approaches. The ambient thermal sensors 320 and the local thermal sensors 322 are also preferably electrically coupled to the controller 304. Thus, the controller 304 may have access to the thermal data which may be gathered by the ambient thermal sensors 320 and the local thermal sensors 322.

Depending on the approach, the ambient thermal sensors 320 and the local thermal sensors 322 may be of any type which would be apparent to one skilled in the art after reading the present description. It should also be noted that the use of thermal sensors 320, 322 are in no way intended to limit the invention. For instance, in other approaches the operating temperature of a given component may be determined using the electrical input, an electrical output, testing data, product information, etc., of the component.

The controller 304 is preferably in communication with each of the plurality of thermal sensors 320, 322 included throughout the system 300, and may thereby receive temperature information which corresponds to various locations and/or components in the system 300. Provided with this temperature information, the controller 304 may be able to regulate the operating conditions of the system 300 and the various electrical components included therein. For instance, the controller 304 may be used to regulate the temperature information corresponding to the components in system 300 and ensure that none of the components exceed their respective recommended operating temperatures. As mentioned above, heat is a thermal byproduct generated by components in a system during normal operation. The amount of heat generated may depend on the operational conditions of the system, including voltage regulator characteristics and system loading. In some system loading instances, thermal runaway of a particular device may occur, or the temperature of a component may exceed a safe operating temperature range. Accordingly, controller 304 is preferably able to make adjustments to the operating settings of the system 300 based, at least in part, on the temperature information received from various thermal sensors 320, 322 positioned throughout the system 300.

For instance, the controller 304 is electrically coupled to, and in communication with, the power supply 302, the voltage regulator 306, and the various electrical components 310, 312, 314 included in the system load 308. Accordingly, the controller 304 may be able to adjust the operating settings of any of the components shown in system 300, e.g., by sending one or more instructions thereto. Moreover, the controller 304 may use information (e.g., such as temperature information) corresponding to the various components included in the system 300 to determine desirable operating settings of the various components. For instance, the controller 304 may use temperature information received from the internal thermal sensors 322 coupled to the power supply 354 and/or the voltage regulator 352 to determine desirable operating settings of the power supply 354 and/or voltage regulator 352.

As mentioned above, the efficiency by which the system 300 is able to operate may be improved by selectively adjusting the operating settings of various components based on temperature information. For example, by developing a more accurate representation of the operating temperature of various electrical components included in a given system and regulating performance based on that temperature information, system halt events may desirably be avoided, thereby significantly improving the efficiency by which the system operates. However, additional system performance information may be regulated in a similar manner. For instance, in different approaches the controller 304 may be used to regulate current draw, voltage drops, operating frequency, signal noise, etc.

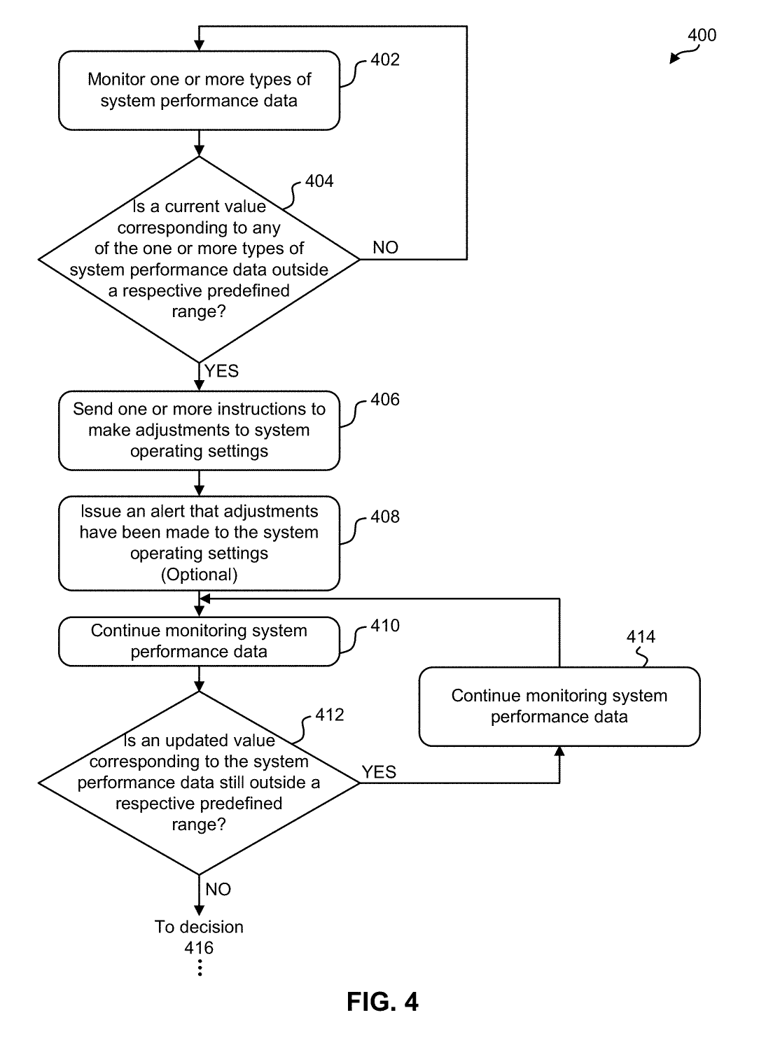

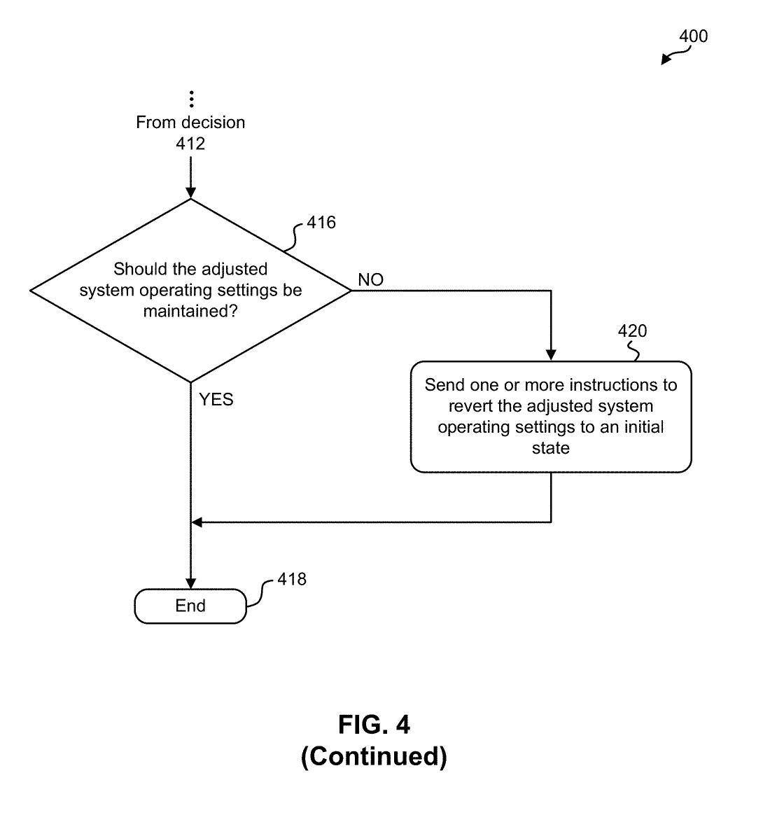

Looking now to FIG. 4, a method 400 for modifying operating settings based on system performance data is illustrated according to one embodiment. The method 400 may be performed in accordance with the present invention in any of the environments depicted in FIGS. 1-3, among others, in various embodiments. Of course, more or less operations than those specifically described in FIG. 4 may be included in method 400, as would be understood by one of skill in the art upon reading the present descriptions.

Each of the processes included in method 400 may be performed by any suitable component of the operating environment. For example, in various embodiments, the method 400 may be partially or entirely performed by a controller (e.g., see 304 of FIG. 3), or some other device having one or more processors therein. The processor, e.g., processing circuit(s), chip(s), and/or module(s) implemented in hardware and/or software, and preferably having at least one hardware component may be utilized in any device to perform one or more processes included in method 400. Illustrative processors include, but are not limited to, a CPU, an application specific integrated circuit (ASIC), a field programmable gate array (FPGA), etc., combinations thereof, or any other suitable computing device known in the art. Thus, in some approaches, method 400 may be a computer-implemented method. In such approaches, the computer used to implement the method 400 may include a controller. It should be noted that the terms computer, processor and controller may be used interchangeably with regards to any of the approaches included herein, such components being considered equivalents in the many various permutations of the present invention.

As shown in FIG. 4, method 400 includes monitoring one or more types of system performance data. See operation 402. As mentioned above, various types of system performance data may be regulated depending on the desired approach. For instance, in different approaches operation 402 may include monitoring “global” (e.g., ambient) temperatures of the system as a whole and/or different regions in the system, “local” temperatures corresponding to one or more respective electrical components included in the system, a current draw of one or more respective electrical components included in the system, a voltage drop across one or more respective electrical components included in the system, etc.

In some approaches, the system may be preconfigured such that the controller receives specific types of system performance data. In other words, the system may be designed such that certain electrical components included in the system automatically send performance data to the controller. In other approaches, the controller may send one or more instructions to various electrical components requesting the performance data be returned to the controller. In still other approaches, various electrical components may be configured to begin sending performance data to the controller in response to a predetermined condition being met. For instance, a voltage regulator may be configured to begin sending performance data to the controller in response to experiencing a certain internal (e.g., “local”) temperature, outputting a sufficiently high voltage, implementing a sufficiently high switching frequency, etc. Similarly, a power supply may be configured to begin sending performance data to the controller in response to experiencing a certain internal (e.g., “local”) temperature, outputting a sufficiently high current, experiencing a sufficiently high voltage drop thereacross, etc.

Referring still to FIG. 4, decision 404 of method 400 further includes determining whether a current value corresponding to any of the one or more types of system performance data is outside a respective predefined range. In other words, decision 404 includes determining whether current values of any of the system performance data is undesirably low or undesirably high. According to an example, which is in no way intended to limit the invention, the operating temperature of a voltage regulator may be one of the types of system performance data monitored in operation 402. Accordingly, decision 404 may include determining whether the operating temperature of the voltage regulator is outside a preferred operating temperature range corresponding to the voltage regulator. Although various ones of the approaches included herein are described with regard to counteracting undesirably high operating temperatures, the desirable operating temperature range for various electrical components may also have a lower limit. Thus, decision 404 may also be used to determine whether the operating temperature of the voltage regulator is undesirably low.

It should also be noted that “outside a respective predefined range” is in no way intended to limit the invention. Rather than determining whether a value is outside a respective predefined range, equivalent determinations may be made, e.g., as to whether a value is above a predetermined threshold, whether a value is inside a predetermined range, whether an absolute value is above a threshold, whether a value is below a threshold, etc., depending on the desired approach. Moreover, the determination may depend on the type of system performance data being evaluated.

Method 400 returns to operation 402 in response to determining that none of the current values corresponding to each of the types of system performance data are outside a respective predefined range. Accordingly, the system performance data may continue to be monitored. Although not shown in FIG. 4, in some approaches method 400 may optionally include receiving one or more different types of system performance data in response to returning to operation 402, e.g., to determine whether other aspects of the system are performing desirably.

Returning to decision 404, method 400 proceeds to operation 406 in response to determining that at least one of the current values corresponding the types of system performance data is outside a respective predefined range. It should be noted that although the remainder of the flowchart is described according to a situation in which one or more current values of only one of the types of system performance data is determined to be outside a predefined range, this is in no way intended to be limiting. In other approaches, any number of the different types of system performance data being monitored may have current values which are determined to be outside respective predefined ranges. Accordingly, any of the processes included in method 400 may be performed with respect to one or more different types of system performance data, e.g., as would be appreciated by one skilled in the art after reading the present description.

Operation 406 includes sending one or more instructions to make adjustments to system operating settings. The adjustments made to the system operating settings are preferably able to cause the system to return to a desirable state of performance. Accordingly, the number, type, intended target, etc., of the one or more instructions sent in operation 406 may depend on the type of system performance data that has been determined as being outside the respective predefined range. Similarly, the number of different types of system performance data determined to be outside their respective predefined ranges may affect the number, type, intended target, etc., of the one or more instructions sent in operation 406.

For example, the system performance data determined to have a current value which is outside a predetermined range may correspond to a power supply (e.g., see 302 of FIG. 3) of a system. Accordingly, the one or more instructions of operation 406 may be sent to the power supply and may be configured to cause the power supply to adjust operating settings which are associated with the undesirable performance data.

According to another example, which is in no way intended to limit the invention, decision 404 may determine that a current value of system performance data corresponding to a voltage regulator is outside a respective predefined range. Accordingly, the one or more instructions sent in operation 406 may be sent to a voltage regulator (e.g., see 306 in FIG. 3) in order to adjust the operating settings of the voltage regulator. In other approaches, decision 404 may determine that a current value of system performance data corresponding to a power supply is outside a respective predefined range. Accordingly, the one or more instructions sent in operation 406 may be sent to a power supply (e.g., see 302 in FIG. 3) in order to adjust the operating settings of the power supply.

As mentioned above, the operating settings adjusted by the one or more instructions sent in operation 406 may also vary depending on the approach. For instance, in some approaches the type electrical component which the instructions are sent to may have an effect on the operating settings effected by the one or more instructions sent. According to an example, the instructions may be sent to a power supply, whereby the one or more instructions may cause an adjustment to the operating settings of the power supply such that the output current of the power supply increases or decreases. Moreover, more than one operating setting of the power supply may be adjusted as a result of the one or more instructions sent in operation 406 in some approaches.

In another example, the instructions may be sent to a voltage regulator, whereby the one or more instructions may cause an adjustment to the operating settings of the voltage regulator such that a switching frequency, a scaling gain, a scaling offset, a gate drive voltage, a dwell time, a number of phases in operation, an output voltage, etc., of the voltage regulator increases or decreases, e.g., as would be appreciated by one skilled in the art after reading the present description. Moreover, more than one operating setting of the voltage regulator may be adjusted as a result of the one or more instructions sent in operation 406 in some approaches.

Referring still to FIG. 4, method 400 may optionally include issuing an alert that adjustments have been made to the system operating settings. See optional operation 408. Whether or not optional operation 408 is performed may depend on the type of system operating settings the adjustments have been made to, user preference, the type of electrical component the adjustments have been made to, a predetermined condition being met, etc. Accordingly, optional operation 408 is in no way intended to be limiting.

The type of alert issued in situations where optional operation 408 is performed may vary. For instance, in various approaches, the alert may be an audible signal, a visual indication (e.g., a warning presented on a display screen, illuminating a status indicator light, a message sent directly to a user, etc.), etc. Moreover, the manner in which the alert is issued may also vary. In different approaches, the alert may be issued by projecting an audible signal using a speaker, displaying a visual que on a display screen, transmitting a wireless and/or wired signal indicating the system operating settings have been adjusted, etc.

Operation 410 includes continuing to monitor system performance data. Thus, system performance data may continue to be monitored following the one or more instructions sent in operation 406 to make adjustments to system operating settings. By continuing to monitor system performance data, the information gathered in operation 410 may be used to determine whether the adjustments made to the system operating settings in response to the one or more instructions sent in operation 406, had a desired effect. Accordingly, decision 412 includes determining whether an updated value corresponding to the system performance data adjusted by the one or more instructions sent in operation 406 is still outside the respective predefined range. In other words, decision 412 includes determining whether the one or more instructions sent in operation 406 had an intended effect on the system performance data.

Decision 412 is preferably performed after a sufficient amount of time has passed since the one or more instructions were sent in operation 406. This delay may allow for changes in system performance to take place and be reflected in the system performance data. In some approaches, operation 410 may implement a temporal component which defines an amount of time that the continued monitoring is performed before decision 412 is determined, thereby allowing the system performance data to update as a result of the one or more instructions sent in operation 406.

As shown, method 400 proceeds to operation 414 in response to determining that the updated value corresponding to the system performance data is still outside the respective predefined range. There, operation 414 includes sending one or more instructions to make additional adjustments to the system operating settings. In some situations, the one or more instructions initially sent in operation 406 may not result in chances to the system performance which are sufficient enough to return the system performance data to a desirable level. Thus, additional adjustments to the system operating settings may be made.

In some approaches, the one or more instructions sent in operation 414 may correspond to making additional adjustments to the same system operating settings adjusted as a result of the one or more instructions sent in operation 406. In other words, operation 414 may result in further adjustments being made to the same system operating settings which operation 406 caused adjustments to. For example, the one or more instructions sent in operation 406 may cause the switching frequency of a voltage regulator to be decreased in order to decrease the operating temperature of the voltage regulator. However, upon determining that the adjustments made in response to the one or more instructions sent in operation 406, operation 414 may send one or more instructions to further decrease the switching frequency of the voltage regulator. In another example, the one or more instructions sent in operation 406 may cause the output current of a power supply to be decreased in order to decrease the power consumption of the power supply. However, upon determining that the adjustments made in response to the one or more instructions sent in operation 406, operation 414 may send one or more instructions to further decrease the output current of the power supply.

However, in other approaches the one or more instructions sent in operation 414 may correspond to making additional adjustments to different system operating settings than those adjusted as a result of the one or more instructions sent in operation 406. In other words, operation 414 may result in adjustments being made to different system operating settings than the system operating settings operation 406 caused adjustments to. For example, the one or more instructions sent in operation 406 may cause the switching frequency of a voltage regulator to be decreased in order to decrease the operating temperature of the voltage regulator. However, upon determining that the adjustments made in response to the one or more instructions sent in operation 406, operation 414 may send one or more instructions to decrease the output voltage of the voltage regulator as well. In another example, the one or more instructions sent in operation 406 may cause the output current of a power supply to be decreased in order to decrease the operating temperature of the power supply. However, upon determining that the adjustments made in response to the one or more instructions sent in operation 406, operation 414 may send one or more instructions to decrease the output voltage of the power supply as well.

In still other approaches, the one or more instructions sent in operation 414 may correspond to making additional adjustments to operating settings of different components than the operating settings of the component adjusted as a result of the one or more instructions sent in operation 406. For example, the one or more instructions sent in operation 406 may cause the switching frequency of a voltage regulator to be decreased in order to decrease the operating temperature of the voltage regulator. However, upon determining that the adjustments made in response to the one or more instructions sent in operation 406, operation 414 may send one or more instructions to decrease the output current of a power supply electrically coupled to an input of the voltage regulator.

From operation 414, method 400 returns to operation 410, whereby system performance data may continue to be monitored following the additional one or more instructions sent in operation 414. It follows that processes 410, 412, and 414 may be repeated in an iterative fashion until current values of the system performance data have returned to being in their respective predetermined ranges. Depending on the approach, processes 410, 412, and 414 may be repeated any desired number of times. However, in some approaches method 400 may implement additional processes to prevent the flowchart from becoming stuck in an endless loop. For instance, in one approach method 400 may request a repair of the system and/or specific components included therein in response to processes 410, 412, and 414 being repeated a certain number of times. Thus, method 400 may be able to determine situations in which the undesirable system performance data cannot be rectified by making adjustments to the performance settings of the system and/or specific components included therein. For example, adjustments to the performance settings of a power supply and/or voltage regulator which has a damaged (e.g., broken) one or more transformers, full-wave bridge rectifiers, filter capacitors, resistor load, etc., therein may not be able to overcome the undesirable performance data thereof. Accordingly, a user, administrator, technician, etc. may be notified of this type of situation, e.g., such that the damaged component may be replaced and/or repaired accordingly.

Returning to decision 412, method 400 proceeds to decision 416 in response to determining that the updated value corresponding to the system performance data is not still outside the respective predefined range. In other words, method 400 proceeds to decision 416 in response to determining that the updated value corresponding to the system performance data has fallen back in the respective predefined range. There, decision 416 includes determining whether the adjusted system operating settings should be maintained. In some approaches, the adjustments made to the system operating settings may have a lasting, positive effect on performance of the system and/or the components included therein. In other words, in some situations the adjustments made to the system operating settings may improve performance of the system and/or the components included therein regardless of the current situation. Thus, it may be preferred to maintain these adjustments even after the values associated with system performance data have returned to desired levels.

However, in other approaches the adjustments made to the system operating settings may only be desirable in certain situations. For instance, the adjustments made to the system operating settings may boost efficiency while sacrificing performance. Thus, once the values associated with system performance data have returned to desired levels, it may be preferred that the system operating settings are returned to their nominal settings. According to an example, which is in no way intended to limit the invention, the switching frequency of a voltage regulator may be decremented in response to determining that the operating temperature of the voltage regulator has risen undesirably high. Although the reduced switching frequency may cause the operating temperature of the voltage regulator to decrease to within a desired range, it may be undesirable that the voltage regulator continue operating at a decreased switching frequency. Accordingly, it may be determined to return the voltage regulator to return to a nominal (e.g., initial) switching frequency.

Returning to decision 416, method 400 may end as a result of determining that the adjusted system operating settings should be maintained. See operation 418. In other words, the adjusted system operating settings may be maintained. However, it should be noted that although method 400 may end upon reaching operation 418, any one or more of the processes included in method 400 may be repeated in order to continue monitoring performance of the system and/or any of the components included therein. In other words, any one or more of the processes included in method 400 may be repeated as desired.

Referring again to decision 416, method 400 proceeds to operation 420 in response to determining that the adjusted system operating settings should not be maintained. There, operation 420 includes sending one or more instructions to revert the adjusted system operating settings to an initial state. In other words, once the system performance data has returned to a desired range, the system operating settings may be returned to a “normal” state. As mentioned above, this outcome may be desirable in situations where performance of the system and/or components included therein is at least somewhat degraded by the adjustments made to the system operating settings. For example, a voltage regulator and/or components coupled to an output of the voltage regulator may be operating at a reduced efficiency as a result of changes that were made to the operating settings of the voltage regulator in order to combat undesirable performance data.

It follows that decision 416 may include weighing the benefits to the system performance data caused by the changes made to the operating settings, with decreases in operating efficiency (if any) of the system and/or specific components included therein.

From operation 420, method 400 proceeds to operation 418 whereby method 400 may end. However, as mentioned above, although method 400 may end upon reaching operation 418, any one or more of the processes included in method 400 may be repeated in order to continue monitoring performance of the system and/or any of the components included therein. In other words, any one or more of the processes included in method 400 may be repeated as desired.

According to an in-use example, which is in no way intended to limit the invention, the various approaches included herein may be implemented in order to allow this voltage regulator to monitor the temperature of the FETs included therein for each phase. Moreover, the voltage regulator may have a thermal warning and/or thermal fault threshold which are predefined. Accordingly, a controller monitoring values of the voltage regulator's operating temperature may cause adjustments to the operating settings of the voltage regulator when the thermal warning and/or thermal fault threshold are exceeded.

In the present example, the voltage regulator has the capability of reducing its switching frequency in response to receiving one or more instructions to do so, e.g., from a managing controller which determined that the thermal warning threshold for the voltage regulator has been exceeded. Accordingly, the FET switching losses of the voltage regulator may be reduced by decreasing the switching frequency of the voltage regulator, thereby reducing the operating temperature. Decreasing the switching frequency may also preventing the FETs from eventually exceeding the thermal fault threshold associated therewith should system operating settings remain untouched despite the above mentioned spike in operating temperature.

Table 1 below illustrates the experimental testing data gathered as a result of stepping down the switching frequency of a voltage regulator using a VR13 reference board.

TABLE 1

| Switching Frequency. | Hottest IC |
|---|---|
| (kHz) | temperature (° C.) |
| 1000 | 71.9 |
| 800 | 66.4 |
| 600 | 60.4 |

As shown, significant decreases in the hottest registered integrated circuit (IC) temperature for the voltage regulator are achieved by stepping down the switching frequency of the voltage regulator.

It should be noted that although the various approaches included herein are described in the context of a managing system controller electrically coupled to various electrical components in the system (e.g., see controller 304 in FIG. 3), any one or more of the approaches included herein may be performed internally with respect to a given component. In other words, any one or more of the processes included in method 400 may be performed by controllers (e.g., processors, ICs, compute modules, etc.) which are implemented in the power supply (e.g., see 302 in FIG. 3), the voltage regulator (e.g., see 306 in FIG. 3), the system load (e.g., see 308 in FIG. 3), etc. Moreover, controllers implemented in the power supply, the voltage regulator, the system load, etc., may communicate with each other, e.g., such that adjustments which complement each other may be made to operating settings of the various components in the system. For example, operating settings of the power supply may be adjusted such that the output current of the power supply is decreased, in combination with adjustments made to the operating settings of the voltage regulator such that the output voltage of the voltage regulator is also decreased. Thus, the one or more instructions sent in operations 406 and 420 may be sent to a specific portion (e.g., subset) of the specific component which the controller is located in, e.g., as would be appreciated by one skilled in the art after reading the present description.

It follows that the various approaches included herein are able to modify system operating settings of various components based on system performance data (e.g., thermal data) in order to achieve overall improved operating efficiency. Moreover, these improvements are in sharp contrast to conventional products which merely disable components and/or the system itself in response to experiencing undesirable performance. By dynamically adjusting system operating settings, e.g., such as voltage amplitudes, output currents, voltage regulator switching frequencies, etc., in response to detecting certain performance conditions, various approaches included herein are able to overcome the shortcomings experienced by conventional products, e.g., such as excessive fan noise, and throttling down system activity.

Again, various ones of the approaches included herein may be able to counteract various different system performance situations, while also ensuring the system remains fully operational. Some of the approaches included herein are able to achieve this operational stability by dynamically adjusting voltage regulator settings and/or power supply settings. Moreover, these adjustments may be made based on current system performance data, thereby enabling an efficient operation management scheme which efficiently adapts to the system as it changes over time and with use.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A computer-implemented method, comprising:
monitoring one or more types of system performance data;
determining whether a current value corresponding to each of the one or more types of system performance data is outside a respective predefined range;
sending one or more instructions to make adjustments to settings of a voltage regulator in response to determining that a current value corresponding to one of the one or more types of system performance data is outside a respective predefined range; and
performing an iterative process which includes:
determining whether an updated value corresponding to the one of the one or more types of system performance data is outside the respective predefined range; and
sending one or more instructions to make additional adjustments to the settings of the voltage regulator in response to determining that the updated value corresponding to the one of the one or more types of system performance data is outside the respective predefined range.

2. The computer-implemented method as recited in claim 1, wherein performing the iterative process includes:
sending one or more instructions to make adjustments to settings of a power supply.

3. The computer-implemented method as recited in claim 1, comprising:
maintaining the adjusted settings of the voltage regulator in response to determining that the updated value corresponding to the one of the one or more types of system performance data is not outside the respective predefined range.

4. The computer-implemented method as recited in claim 1, comprising:
sending one or more instructions to revert the adjusted settings of the voltage regulator to an initial state in response to determining that the at least one value is not outside the respective predefined range.

5. The computer-implemented method as recited in claim 1, wherein the one or more types of system performance data are selected from a group consisting of:
temperature, current, and voltage.

6. The computer-implemented method as recited in claim 1, wherein sending one or more instructions to make adjustments to the settings of the voltage regulator includes:
sending one or more instructions to modify at least one setting of the voltage regulator selected from a group consisting of: a switching frequency, a scaling gain, a scaling offset, a gate drive voltage, a dwell time, a number of phases in operation, and an output voltage.

7. The computer-implemented method as recited in claim 1, wherein sending one or more instructions to make adjustments to the settings of the voltage regulator includes:
sending one or more instructions to modify the switching frequency of the voltage regulator.

8. The computer-implemented method as recited in claim 1, comprising:
issuing an alert that adjustments have been made to the settings of the voltage regulator.

9. The computer-implemented method as recited in claim 1, wherein each of the operations is performed by a computer coupled to the voltage regulator.

10. A computer program product for adjusting voltage settings, the computer program product comprising a non-transitory computer readable storage medium, the computer readable storage medium having program code stored thereon, the program code executable by a computer to cause the computer to perform a process comprising:
monitoring, by the computer, one or more types of system performance data;
determining, by the computer, whether a current value corresponding to each of the one or more types of system performance data is outside a respective predefined range;
sending, by the computer, one or more instructions to make adjustments to settings of a voltage regulator in response to determining that a current value corresponding to one of the one or more types of system performance data is outside a respective predefined range; and
performing, by the computer, an iterative process which includes:
determining whether an updated value corresponding to the one of the one or more types of system performance data is outside the respective predefined range; and
sending one or more instructions to make additional adjustments to the settings of the voltage regulator in response to determining that the updated value corresponding to the one of the one or more types of system performance data is outside the respective predefined range.

11. The computer program product as recited in claim 10, wherein performing the iterative process includes:
sending one or more instructions to make adjustments to settings of a power supply.

12. The computer program product as recited in claim 10, the program code executable by the computer to cause the computer to perform the process comprising:
maintaining, by the computer, the adjusted settings of the voltage regulator in response to determining that the updated value corresponding to the one of the one or more types of system performance data is not outside the respective predefined range.

13. The computer program product as recited in claim 10, the program code executable by the computer to cause the computer to perform the process comprising:
sending, by the computer, one or more instructions to revert the adjusted settings of the voltage regulator to an initial state in response to determining that the at least one value is not outside the respective predefined range.

14. The computer program product as recited in claim 10, wherein the one or more types of system performance data are selected from a group consisting of:
temperature, current, and voltage.

15. The computer program product as recited in claim 10, wherein sending one or more instructions to make adjustments to the settings of the voltage regulator includes:
sending one or more instructions to modify at least one setting of the voltage regulator selected from a group consisting of: a switching frequency, a scaling gain, a scaling offset, a gate drive voltage, a dwell time, a number of phases in operation, and an output voltage.

16. The computer program product as recited in claim 10, wherein sending one or more instructions to make adjustments to the settings of the voltage regulator includes:
sending one or more instructions to modify the switching frequency of the voltage regulator.

17. The computer program product as recited in claim 10, the program code executable by the computer to cause the computer to perform the process comprising:
issuing, by the computer, an alert that adjustments have been made to the settings of the voltage regulator.

18. The computer program product as recited in claim 10, wherein each of the operations is performed by a computer coupled to the voltage regulator.

19. A system, comprising:
a voltage regulator;
a processor in communication with the voltage regulator; and
logic executable by the processor, the logic being configured to:
monitor, by the processor, one or more types of system performance data;
determine, by the processor, whether a current value corresponding to each of the one or more types of system performance data is outside a respective predefined range;
send, by the processor, one or more instructions to make adjustments to settings of a voltage regulator in response to determining that a current value corresponding to one of the one or more types of system performance data is outside a respective predefined range; and
perform, by the processor, an iterative process which includes:
determining whether an updated value corresponding to the one of the one or more types of system performance data is outside the respective predefined range; and
sending one or more instructions to make additional adjustments to the settings of the voltage regulator in response to determining that the updated value corresponding to the one of the one or more types of system performance data is outside the respective predefined range.

20. The system as recited in claim 19, the logic being configured to:
send, by the processor, one or more instructions to revert the adjusted settings of the voltage regulator to an initial state in response to determining that the at least one value is not outside the respective predefined range,
wherein the one or more types of system performance data includes a temperature of each of the components electrically coupled to an output of the voltage regulator.
